(19) United States
(12) Patent Application Publication
(10) Pub. No.: US 2006/0274111 A1
(43) Pub. Date: Dec. 7, 2006

(54) PRINTHEAD AND INKJET IMAGE FORMING APPARATUS HAVING THE SAME

(76) Inventor: Seo-hyun CHO, Seongnam-si (KR)

Correspondence Address: STANZIONE & KIM, LLP, 919 18TH STREET, N.W., SUITE 440, WASHINGTON, DC, 20006, US

(21) Appl. No.: 11/420,836

(22) Filed: May 30, 2006

(30) Foreign Application Priority Data
Jun. 1, 2005 (KR) 2005-46736

(51) Int. Cl. B41J 2/15

(52) U.S. Cl. 347/40

(57) ABSTRACT

A printhead including a nozzle unit having a main nozzle array to eject ink on a print medium to print an image, and a compensating nozzle unit having a secondary nozzle array which is separately installed in a transferring direction of the print medium to compensate for malfunctioning nozzles in the nozzle unit, wherein each nozzle disposed in the secondary nozzle array of the compensating nozzle unit is positioned between nozzles disposed in the main nozzle array of the nozzle unit. The inkjet image forming apparatus having this printhead can prevent printing defects caused by malfunctioning nozzles, such as missing lines.

### CROSS-REFERENCE TO RELATED APPLICATIONS

This application claims the benefit under 35 U.S.C. § 119 of Korean Patent Application No. 2005-46736, filed on Jun. 1, 2005, in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to a printhead of an image forming apparatus that can compensate for missing dots caused by malfunctioning nozzles.

2. Description of the Related Art

In general, an inkjet image forming apparatus forms images by ejecting ink onto a print medium. A nozzle unit having a plurality of nozzles for ejecting ink is installed in a printhead of the inkjet image forming apparatus. When a nozzle malfunctions, a visible unprinted line (column), such as a white line, is visible on the print medium P due to the malfunctioning nozzle that leaves a missing (unprinted) dot in each printed row.

FIG. 1 illustrates a printing pattern when one nozzle of a conventional nozzle unit in a conventional inkjet image forming apparatus malfunctions. FIGS. 2A through 2D are pixel images for explaining a conventional method of compensating for a malfunctioning nozzle unit of the conventional inkjet image forming apparatus.

Referring to FIG. 1, the conventional inkjet image forming apparatus forms an ink image by ejecting ink I from nozzles 82 formed in the conventional nozzle unit 80 onto the print medium P. The conventional nozzle unit 80 is installed in a direction perpendicular to a transferring direction of the print medium P, and ejects ink droplets onto the print medium P. Thus, when a nozzle 84 malfunctions, a visible unprinted line (column), such as a white line, is visible on the print medium P. Such a printing defect is less visible when an image of a low printing density is formed. However, when printing a solid pattern or an image of a high printing density, the white line appears in a printed image in the transferring direction of the print medium P, thereby substantially affecting a printed image quality.

A conventional method of compensating for the printed image quality degradation due to a malfunctioning nozzle is disclosed in U.S. Pat. No. 5,581,284. FIGS. 2A through 2D are same figures as FIGS. 3 through 6 of U.S. Pat. No. 5,581,284.

U.S. Pat. No. 5,581,284 discloses a conventional method of compensating for a malfunctioning nozzle in a conventional inkjet image forming apparatus. The malfunctioning nozzle can be a bad or non-droplet ejecting nozzle. When a location 63 in which the malfunctioning nozzle should have ejected a black ink droplet (K) is identified (see FIG. 2A), ink droplets of other colors (i.e., cyan (C), magenta (M), and yellow (Y) droplets are sequentially ejected onto the location 63. These processes are illustrated in FIGS. 2B, 2C, and 2D. As described above, the missing black ink droplet can be replaced by printing the cyan (C), magenta (M), and yellow (Y) ink droplets at the same location 63 of the print medium at which the malfunctioning nozzle should have ejected the black (K) ink droplet, and the resulting black ink droplet is called a process black (P) or composite black droplet. However, this method is useful to compensate for malfunction of a nozzle ejecting black (K) ink, but cannot compensate for malfunction of nozzles ejecting other colors. Moreover, since nozzles for cyan (C), magenta (M), and yellow (Y) ink do not operate when only black color is printed, the process black (P) droplet can be formed using the cyan (C), magenta (M), and yellow (Y) ink droplets, but when a color image is printed, that is, the nozzles for cyan (C), magenta (M), and yellow (Y) ink operate, this conventional method of compensating for a malfunctioning black (K) nozzle cannot be performed. Further, when one of the nozzles ejecting cyan (C), magenta (M), and yellow (Y) ink used to compensate for a malfunctioning black (K) ink nozzle also malfunctions, other colors such as red (yellow+magenta), green (cyan+yellow), or blue (cyan+magenta) color must be used to compensate for the malfunctioning color nozzle, and thus the printed image quality is deteriorated. In addition, since color inks are used together to compensate for the black (K) ink malfunctioning nozzle, the consumption of the color inks increases. Therefore, a lifetime of a cartridge is decreased.

Japanese Patent Publication No. 2004-122521 discloses another conventional method of compensating for degradation of an image due to a malfunctioning nozzle. In this case, adjacent nozzles positioned at either sides of the malfunctioning nozzle are used to compensate for the malfunctioning nozzle. Sizes of ink droplets ejected from the adjacent nozzles are increased to compensate for the malfunctioning nozzle. However, since the adjacent nozzles are positioned at one dot away from the malfunctioning nozzle, compensating for missing dots due to the malfunctioning nozzle may be limited.

According to the above described conventional methods, a printing defect caused by a malfunctioning nozzle may negatively affect a high-quality and high-speed printing operation of the conventional image forming apparatus. Hence, there is a need of compensating for malfunctioning nozzles while preserving the printed image quality.

### SUMMARY OF THE INVENTION

The present general inventive concept provides a printhead to effectively compensate for image degradation due to malfunctioning nozzles in an inkjet image forming apparatus.

The present general inventive concept also provides a printhead for an inkjet image forming apparatus, which can overcome compensating limitations of the conventional methods and minimize effects of malfunctioning nozzles on a printed image quality.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing a printhead including a nozzle unit having a main nozzle array to eject ink on a print medium to print an image, and a compensating nozzle unit having a secondary nozzle array separately installed in a transferring direction of the print medium to compensate for malfunctioning nozzles in the nozzle unit, wherein each nozzle disposed in the secondary nozzle array of the compensating nozzle unit is positioned between nozzles disposed in the main nozzle array of the nozzle unit.

Each nozzle disposed in the secondary nozzle array of the compensating nozzle unit may be positioned in a range of ¼ to ¾ of a gap between two adjacent nozzles disposed in the main nozzle array of the nozzle unit.

Each nozzle disposed in the secondary nozzle array of the compensating nozzle unit may be positioned substantially at a center of a gap between two adjacent nozzles disposed in the main nozzle arrays of the nozzle unit

Diameters of nozzles in the compensating nozzle unit may be equal to or larger than diameters of nozzles in the nozzle unit, and equal to or less than twice the diameters of nozzles in the nozzle unit.

Each nozzle disposed in the secondary nozzle array of the compensating nozzle unit may have an elliptical shape.

The nozzle unit may have a length corresponding to a width of the print medium.

The compensating nozzle unit may have a length corresponding to a width of the print medium.

The printhead may include a plurality of head chips, each including the nozzle unit and the compensating nozzle unit, wherein the plurality of the head chips may be installed in one line or in two lines alternating with one another, along a direction perpendicular to the transferring direction of the print medium.

The main nozzle array may include a first and a second nozzle array to eject ink of same color and the first and the second array are separately positioned at a predetermined distance from each other along the transferring direction of the print medium, and nozzles of the first and the second nozzle array are positioned to alternate one another in a direction perpendicular to the transferring direction of the print medium.

The foregoing and/or other aspects of the present general inventive concept may also be achieved by providing an inkjet forming apparatus comprising a printhead to eject ink on a print medium to print an image thereon, wherein the printhead includes a nozzle unit having a main nozzle array to eject ink on a print medium to print an image, and a compensating nozzle unit having a secondary nozzle array which is separately installed in a transferring direction of the print medium to compensate for malfunctioning nozzles in the nozzle unit, wherein each nozzle disposed in the secondary nozzle array of the compensating nozzle unit is positioned between nozzles disposed in the main nozzle array of the nozzle unit.

The inkjet forming apparatus may further comprise a detecting unit to detect malfunctioning nozzles in the nozzle unit.

The inkjet forming apparatus may further comprise a control unit to control the printhead to compensate for the malfunctioning nozzles in the nozzle unit based on information on the malfunctioning nozzles generated by the detecting unit.

Each nozzle disposed in the secondary nozzle array of the compensating nozzle unit may be in a range of ¼ to ¾ of a gap between two adjacent nozzles disposed in the main nozzle arrays of the nozzle unit.

Each nozzle disposed in the secondary nozzle array of the compensating nozzle unit may be substantially at a center of a gap between two adjacent nozzles disposed in the main nozzle arrays of the nozzle unit.

Diameters of nozzles in the compensating nozzle unit may be equal to or larger than diameters of nozzles in the nozzle unit, and equal to or less than twice the diameters of the nozzles in the nozzle unit.

The control unit may control the printhead such that a size of ink droplets ejected form nozzles in the compensating nozzle unit is equal to or larger than a size of ink droplets ejected from the nozzle unit, and equal to or less than twice the size of ink droplets ejected from the nozzle unit.

Each nozzle disposed in the secondary nozzle array of the compensating nozzle unit may have an elliptical shape.

The nozzle unit may have a length corresponding to a width of the print medium.

The compensating nozzle unit may have a length corresponding to a width of the print medium.

The inkjet forming apparatus may include a plurality of head chips, each including the nozzle unit and the compensating nozzle unit, wherein the plurality of the head chips may be installed in one line or in two lines to alternate with one another, along a direction perpendicular to the transferring direction of the print medium.

The main nozzle array may include a first and second nozzle array to eject ink of the same color and the first nozzle array and the second nozzle array are separately positioned from each other at a predetermined distance along the transferring direction of the print medium, and each nozzle in the first and second nozzle arrays are positioned to alternate one another in a direction perpendicular to the transferring direction of the print medium.

The foregoing and/or other aspects of the present general inventive concept may also be achieved by providing a printhead usable with an inkjet image forming apparatus, the printhead including a plurality of head chips, each head chip including a first nozzle array to print an image on a print medium that is moving in a first direction and a second nozzle array to compensate for malfunctioning nozzles of the first nozzle array by printing an image in areas corresponding to the malfunctioning nozzles, and the plurality of head chips being arranged in a second direction to extend along a width of the printing medium.]

The foregoing and/or other aspects of the present general inventive concept may also be achieved by providing a printhead, including a head chip, a nozzle unit formed in the head chip having nozzles to eject ink, and a compensating nozzle unit formed in the head chip and having compensating nozzles to eject compensating solution to diffuse the ink.

The foregoing and/or other aspects of the present general inventive concept may also be achieved by providing an inkjet image forming apparatus including a printhead including a first nozzle array to print an image on a print medium that is moving in a first direction, and a second nozzle array to compensate for malfunctioning nozzles of the first nozzle array, at least one malfunctioning nozzle detection unit to detect malfunctioning nozzles of the first nozzle array, and a control unit to control the second nozzle to print the image at locations where nozzles of the first nozzle array are detected as malfunctioning by the at least one malfunctioning nozzle detection unit.

The foregoing and/or other aspects of the present general inventive concept may also be achieved by providing an inkjet image forming apparatus including a data input unit to receive an image to be printed by the inkjet image forming apparatus, a printhead to eject ink to print the image on a print medium, the printhead including a nozzle unit and a compensating nozzle unit, a detecting unit to detect malfunctioning nozzles of the nozzle printhead, and a control unit to receive the image to be printed from the data input unit, to receive information on the malfunctioning nozzles from the detecting unit, to control the nozzle unit to eject ink on the printing medium according to the image to be printed, and to control the compensating nozzle unit to eject ink according to the image to be printed to compensate for the malfunctioning nozzles.

The foregoing and/or other aspects of the present general inventive concept may also be achieved by providing an image forming apparatus, including a printhead to print to a print medium, the printhead including a first plurality of nozzles to eject ink to a plurality of first portions of the print medium and a second plurality of nozzles to eject compensating solution to a plurality of second portions of the print medium that are adjacent to the first portions, a detecting unit to detect one or more of the first nozzles that malfunction, and a control unit to control the printhead according to which of the one or more first nozzles that malfunction.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a printing pattern obtained when a nozzle unit of a conventional inkjet image forming apparatus malfunctions;

FIGS. 2A through 2D are pixel images for explaining a conventional method of compensating for a malfunctioning nozzle unit of a conventional inkjet image forming apparatus;

FIG. 3 is a schematic cross-sectional view of an inkjet image forming apparatus according to an embodiment of the present general inventive concept;

FIG. 4 illustrates a printhead of a printhead unit and a print medium illustrated in FIG. 3, according to an embodiment of the present general inventive concept;

FIG. 5 illustrates another printhead of a printhead unit and a print medium illustrated in FIG. 3, according to another embodiment of the present general inventive concept;

FIG. 6 illustrates an enlarged portion ‘A’ of the printhead illustrated in FIG. 5;

FIG. 7 illustrates a printhead having elliptical nozzles in a compensating nozzle unit, according to another embodiment of the present general inventive concept;

FIG. 8 illustrates a printhead having chip-type nozzle units according to another embodiment of the present general inventive concept;

FIG. 9 illustrates a compensating nozzle unit installed in an additional printhead according to another embodiment of the present general inventive concept; and

FIG. 10 is a block diagram illustrating an inkjet image forming apparatus capable of compensating for a malfunctioning nozzle, according to an embodiment of the present general inventive concept.

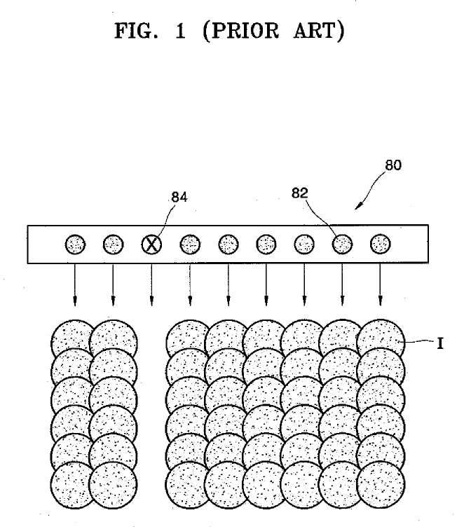

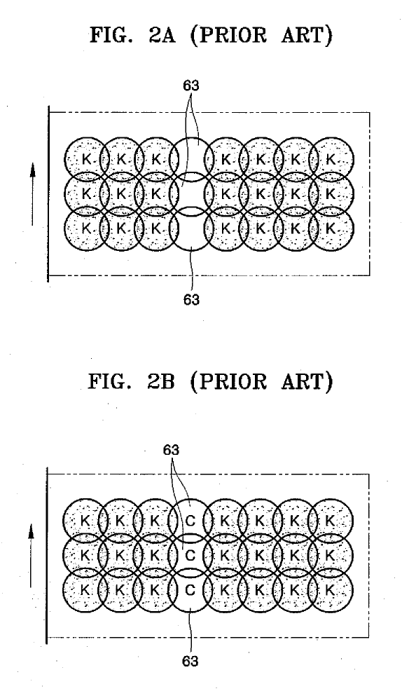

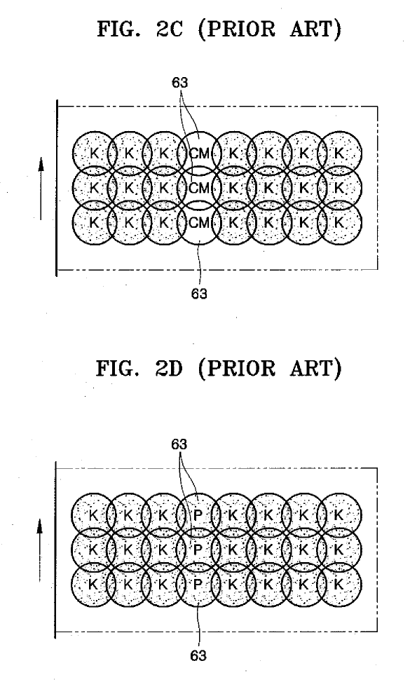

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

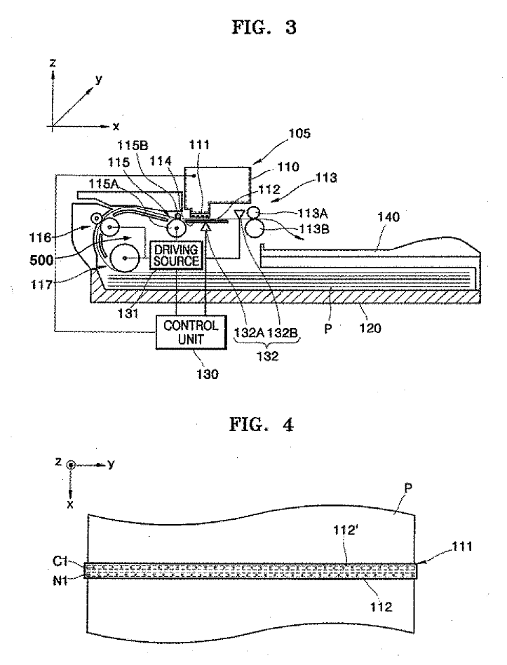

FIG. 3 is a cross-sectional view of an inkjet image forming apparatus according to an embodiment of the present general inventive concept. Referring to FIG. 3, the inkjet image forming apparatus includes a feeding cassette 120, a printhead unit 105, a supporting member 114 opposite to the printhead unit 105, a detecting unit 132 to detect malfunctioning nozzles, a print medium transferring unit 500, to transfer a print medium P in a first direction, and a stacking unit 140 on which the discharged print medium P is stacked.

The print medium P is initially stacked in the feeding cassette 120. The print medium is transferred from the feeding cassette 120 to a printhead 111 by the print medium transferring unit 500, which will be described later. In the present embodiment, a first direction (i.e. an x direction) indicates a direction of transferring the print medium P, while a second direction (i.e., an y direction) indicates a direction of a width of the print medium P. The first direction may or may not be perpendicular to the second direction.

The print medium transferring unit 500 transfers the print medium P along a predetermined path and includes a pick-up roller 117, an auxiliary roller 116, a feeding roller 115, and a discharging roller 113. The print medium transferring unit 500 is driven by a driving source 131, such as a motor, and provides a transferring force to transfer the print medium P along the predetermined path. The driving source 131 is controlled by a control unit 130.

The pick-up roller 117 is installed on one side of the feeding cassette 120. The pick-up roller 117 is rotated while pressing on a top side of the print medium P stacked in the feeding cassette 120, thereby feeding the print medium P outside of the feeding cassette 120.

The feeding roller 115 is installed at an inlet side of the printhead 111 and feeds the print medium P to the printhead 111 after the pick-up roller 117 draws out the print medium P from the feeding cassette 120. The feeding roller 115 may align the print medium P before the print medium P passes through the printhead 111 such that ink can be ejected to an appropriate region of the print medium P. The feeding roller 115 includes a driving roller 115A to supply a transferring force to transfer the print medium P towards the printhead 111, and an idle roller 115B to elastically engage with the driving roller 115A. The auxiliary roller 116 that transfers the print medium P may be installed between the pick-up roller 117 and the feeding roller 115.

The discharging roller 113 that is installed at an outlet side of the printhead 111 discharges the print medium P, on which a printing operation has been completed, outside of the image forming apparatus. The discharged print medium P is stacked on the stacking unit 140. The discharging roller 113 may include a star wheel 113A installed in the width direction of the print medium P, and a supporting roller 113B that is opposite to the star wheel 113A and supports a rear side of the print medium P. The print medium P may wrinkle due to ink ejected onto a top side of the print medium P while passing through a nozzle unit 112. If the wrinkling is severe, the print medium P contacts a bottom surface of the nozzle unit 112 or a body 110, wet ink is spread on the print medium P, and an ink image printed thereon may be contaminated. A predetermined distance between the print medium P and the nozzle unit 112 may not be maintained due to the wrinkles of the print medium P. The star wheel 113A prevents the print medium P fed under the nozzle unit 112 from contacting the bottom surface of the nozzle unit 112 or the body 110, or maintains a predetermined distance between the print medium P and the bottom surface of the nozzle unit 112 or the body 110. The star wheel 113A is installed such that at least a portion of the star wheel 113A protrudes from the nozzle unit 112, and contacts at a point of a top surface of the print medium P. Accordingly, the star wheel 113A contacts the point of a top side of the print medium P so that the ink image that has been printed with the ink ejected from the nozzle unit 112 and is not yet dried is not contaminated. Alternatively, a plurality of star wheels 113A may be installed to smoothly transfer the print medium P. When the plurality of star wheels 113A are installed parallel to the transferring direction of the print medium P, a plurality of supporting rollers 113B corresponding to the star wheels 113A may be further installed.

When the printing operation is continuously performed, the print medium P is discharged and stacked on the stacking unit 140, and subsequently a next print medium P′ may be discharged before the ink on the top side of the print medium P is dried, so that a rear side of the next print medium P′ may be contaminated by wet ink from the top side of the print medium P. To prevent this problem, an individual drying unit (not illustrated) may be further installed.

The supporting member 114 is installed below the printhead 111 and supports the rear side of the print medium P to maintain a predetermined distance between the nozzle unit 112 and the print medium P. The distance between the nozzle unit 112 and the print medium P is between 0.5-2.5 mm.

The detecting unit 132 detects a malfunctioning nozzle of the nozzle unit 112 formed on the printhead 111. The malfunctioning nozzle indicates a bad or non-droplet ejecting nozzle. That is, the malfunctioning nozzle exists when ink is not ejected from nozzles due to several reasons or when a smaller amount of ink is ejected.

The detecting unit 132 may be installed to detect whether a malfunctioning nozzle exists in the nozzle unit 112 before the printing operation starts or while the printing operation is being performed. Accordingly, the detecting unit 132 may include a first detecting unit 132A to detect malfunctioning nozzles in the nozzle unit 112 before the printing operation and a second detecting unit 132B to detect malfunctioning nozzles in the nozzle unit 112 during the printing operation. The first detecting unit 132A detects whether nozzles are clogged by radiating light directly onto the nozzle unit 112, and the second detecting unit 132B detects whether a defective nozzle exists in the nozzle unit 112 by radiating light onto the print medium P when the print medium P is transferred along the predetermined path after the printing operation.

In general, printheads usable with inkjet image forming apparatuses are classified into two types according to an actuator that provides an ejecting force to ink droplets. A printhead of a first type is a thermal driving printhead that generates bubbles in ink using a heater, thereby causing ink droplets to be ejected due to an expanding force of the bubbles. A printhead of a second type is a piezoelectric driving printhead that ejects ink droplets using a pressure applied to ink due to deformation of a piezoelectric device. When using the thermal driving printhead, the heater used for ejecting ink being disconnected, a driving circuit of the heater being broken or malfunctions of nozzles that occurred due to damages of an electrical element (such as a field emission transistor (FET), and the like) can be easily detected. Likewise, when using the piezoelectric driving printhead, defects of the piezoelectric device or malfunctions of nozzles that occurred due to damages of a driving circuit for driving the piezoelectric device can be easily detected. The malfunctions of the nozzles occurred due to the above causes can be detected by the first detecting unit 132A before the printing operation starts.

In contrast with the above easy-to-detect causes of malfunctioning of a nozzle, causes of malfunctioning of a nozzle may not be easily detected when the malfunctioning nozzle is clogged with foreign matter. When the causes of a malfunctioning nozzle cannot be easily detected, a test page printing is performed. If a malfunctioning nozzle exists in the nozzle unit 112, a print concentration of a portion of the print medium P printed by (or that should have been printed by) the malfunctioning nozzle is lower than a print concentration of a portion of the print medium P printed by a normal functioning nozzle. Since the portion of the print medium P printed with lower concentration is detected by the second detecting unit 132B, a position (or location) of the malfunctioning nozzle can be detected using the second detecting unit 132B. That is, the malfunctioning nozzle can be detected using the above-described methods during both by the test page printing and an actual image printing.

A configuration and an operation of the first detecting unit 132A are similar to a configuration and an operation of the second detecting unit 132B and thus, for the convenience of explanation, only the configuration and operation of the second detecting unit 132B will now be described. An embodiment of the second detecting unit 132B may be an optical sensor including a light-emitting sensor, such as a light emitting diode, to radiate light onto the print medium P and a light-receiving sensor to receive light reflected from the print medium P. An output signal from the light-receiving sensor is provided to the second detecting unit 132B. The second detecting unit 132B detects whether a malfunctioning nozzle exists in the nozzle unit 112 based on the output signal, and information about whether the malfunctioning nozzle exists in the nozzle unit 112 is transmitted to the control unit 130 that will be described later. The detecting unit 132 detects whether the malfunctioning nozzle exists in the nozzle unit 112 using the above-described processes. The light emitting sensor and the light receiving sensor can be formed as one unit or as separate units. The structure and functions of the optical sensor are well-known to those of ordinary skill in the art, and thus a detailed description thereof will be omitted.

The printhead unit 105 prints an image by ejecting ink onto the print medium P, and includes the body 110, the printhead 111 installed in one side of the body 110, and the nozzle unit 112 formed on the printhead 111. The feeding roller 115 is rotatably installed at an inlet side of the nozzle unit 112, and the discharging roller 113 is rotatably installed at an outlet side of the nozzle unit 112.

The printhead 111 includes the nozzle unit 112 to eject ink onto the print medium P to print an image and a compensating nozzle unit 112′ to compensate for possible malfunctioning nozzles of the nozzle unit 112. The printhead 111 may use heat energy or a piezoelectric device to eject ink, and is manufactured to have a high resolution through a semiconductor manufacturing process such as etching, deposition or sputtering. The nozzle unit 112 and the compensating nozzle unit 112′ may be installed in a single printhead or in separate printheads.

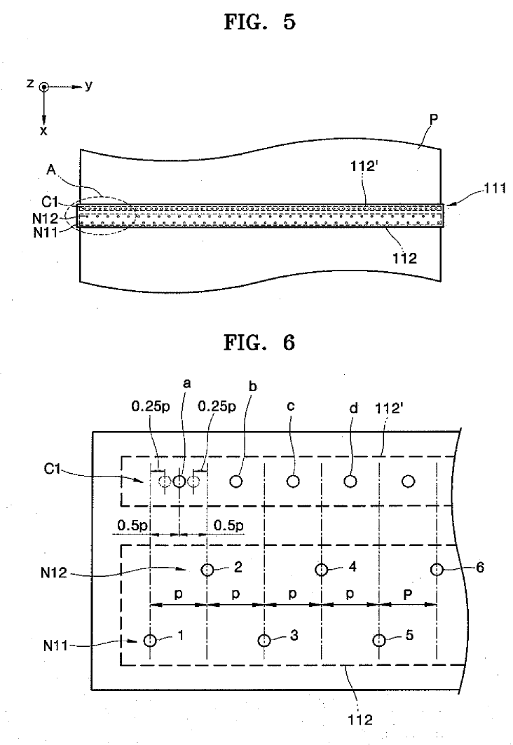

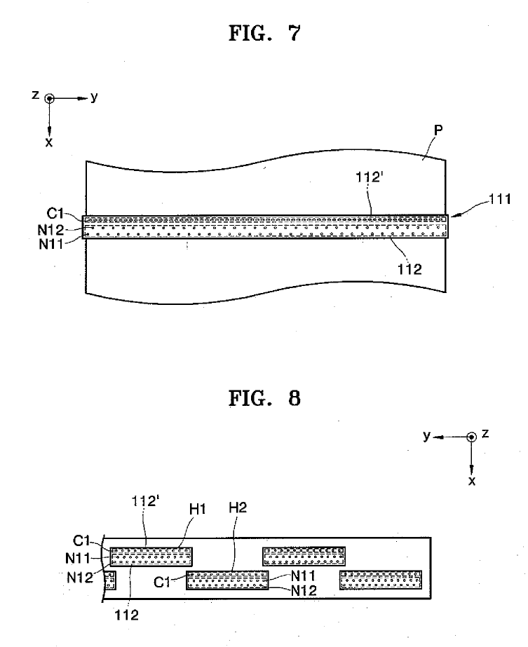

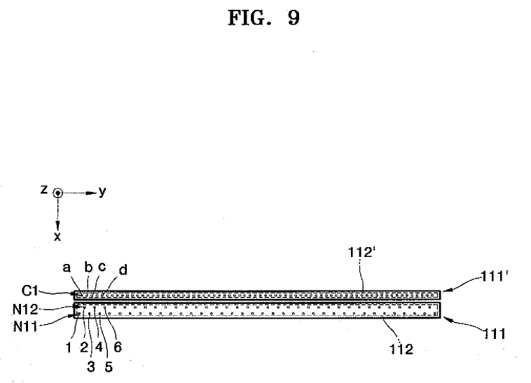

FIG. 4 illustrates a printhead of a printhead unit and a print medium illustrated in FIG. 3, according to an embodiment of the present general inventive concept. FIG. 5 illustrates another printhead of a printhead unit and a print medium illustrated in FIG. 3, according to another embodiment of the present general inventive concept. FIG. 6 illustrates an enlarged portion ‘A’ of the printhead illustrated in FIG. 5. FIG. 7 illustrates a printhead having elliptical nozzles in a compensating nozzle unit according to another embodiment of the present general inventive concept. FIG. 8 illustrates a printhead having chip-type nozzle units according to another embodiment of the present general inventive concept. FIG. 9 illustrates a compensating nozzle unit installed in an additional printhead according to another embodiment of the present general inventive concept.

Referring to FIGS. 4 through 9, reference numeral 112 indicates a nozzle unit, reference numeral 112′ indicates a compensating nozzle unit, N1, N11, and N12 indicate nozzle arrays arranged in the nozzle unit 112, C1 indicates a nozzle array arranged in the compensating nozzle unit 112′, reference numeral 111 indicates a printhead having the nozzle unit 112, and reference numeral 111′ indicates a printhead having the compensating nozzle unit 112′. Like reference numerals in the drawings denote like elements having same structures and functions for convenience of explanation. In FIG. 6, reference numerals 1, 2, 3, 4, 5, and 6 indicate nozzles in the nozzle unit 112 and reference characters a, b, c, and d indicate nozzles in the compensating nozzle unit 112′.

In FIG. 4, the nozzle unit 112 includes a nozzle array N1 ejecting ink to print an image on a print medium P, as illustrated in FIG. 4. In FIG. 5, according to another embodiment of the present general inventive concept, the nozzle unit 112 includes a first nozzle array N11 and a second nozzle array N12, which are separated from each other along a transferring direction of the print medium P and eject ink of the same color. As illustrated in FIG. 6, each of the nozzles 1, 3, and 5 in the first nozzle array N11 and each of the nozzles 2, 4, and 6 in the second nozzle array N12 may be arranged alternately with one another in a y direction to improve printing resolution. That is, the nozzles of the second nozzle array are positioned in between the nozzles of the first nozzle array in the y direction. A nozzle arrangement as illustrated in FIGS. 5 and 6 and as described above may also be referred to as a zig-zag arrangement. In addition, although the printheads illustrated in FIGS. 4 and 5 eject only ink of one color, the present general inventive concept can be applied to a color printhead ejecting ink of different colors.

For convenience of explanation, the structures and arrangements of the nozzle unit 112 and the compensating nozzle unit 112′ according to an embodiment of the present general inventive concept will described with reference to FIGS. 5 and 6. In FIG. 6, ‘p’ indicates a nozzle pitch, that is, a distance (gap) between adjacent nozzles.

The compensating nozzle unit 112′ is used to compensate for malfunctioning nozzles of the nozzle unit 112 detected by the detecting unit 132. As illustrated in FIG. 6, according to an embodiment of the present general inventive concept, each of the nozzles a, b, c, and d disposed in the nozzle array C1 of the compensating nozzle unit 112′ is respectively positioned in the y direction at a predetermined position between two adjacent nozzles of the nozzles 1, 2, 3, 4, 5, and 6 disposed in the nozzle arrays N11 and N12 of the nozzle unit 112. Here, the predetermined position of each of the nozzles a, b, c, and d disposed in the nozzle array C1 of the compensating nozzle unit 112′ may be substantially at a center or in a range of ¼ to ¾ of a gap between two adjacent nozzles disposed in the nozzle arrays N11 and N12 of the nozzle unit 112 so as to minimize a visible printing defect caused by missing dots due to the malfunctioning nozzles. That is, when the nozzles 1 and 2 in the nozzle unit 112 malfunction, the nozzle a in the compensating nozzle unit 112′ is used to compensate for the malfunctioning nozzles 1 and 2 , when the nozzles 2 and 3 in the nozzle unit 112 malfunction, the nozzle b in the compensating nozzle unit 112′ is used to compensate for the malfunctioning nozzles 2 and 3, and when the nozzles 3 and 4 in the nozzle unit 112 malfunction, the nozzle c in the compensating nozzle unit 112′ is used to compensate for the malfunctioning nozzles 3 and 4. Actually, ink droplets ejected from the compensating nozzle unit 112′ are mixed with adjacent ink droplets ejected from the nozzle unit 112 to compensate for any malfunctioning nozzles. Therefore, the compensation nozzle unit 112′ can compensate for any malfunctioning nozzles in the nozzle unit 112, thereby minimizing the visible missing line, such as a white line. The ink ejection of the compensating nozzle unit 112′ is controlled by the control unit 130.

Diameters of the nozzles a, b, c, and d disposed in the nozzle array C1 of the compensating nozzle unit 112′ may be equal to or larger than diameters of the nozzles 1, 2, 3, 4, 5, and 6 disposed in the nozzle array N11 and N12 of the nozzle unit 112, in order to effectively mix ink droplets. However, when a size of an ink droplet ejected by the compensating nozzle unit 112′ is too large, the ink droplet may be undesirably mixed with ink droplets ejected on other portions of the print medium P, thereby significantly degrading the printed image quality. Accordingly, the diameters of the nozzles in the compensating nozzle unit 112′ may be equal to or less than twice the diameters of the nozzles in the nozzle unit 112. According to another embodiment of the present general inventive concept, the control unit 130 can control sizes of the ink droplets ejected by the nozzles of the compensating nozzle unit 112′ by adjusting a heating temperature for a thermal driving printhead or a driving timing of a piezoelectric device for a piezoelectric driving printhead. The control unit 130 may control the size of the ink droplets ejected by the nozzles in the compensating nozzle unit 112′ to be greater than the size of the ink droplets ejected by the nozzles in the nozzle unit 112 and equal to or less than twice the size of the ink droplets ejected by the nozzles in the nozzle unit 112.

As described above, the compensating nozzle unit 112′ should be designed not to undesirably mix the ink droplets ejected from compensating nozzle unit 112′ with the ink droplets ejected on the other portions of the print medium P. In an embodiment of the present general inventive concept, each of the nozzles disposed in the nozzle array C1 of the compensating nozzle unit 112′ may have an elliptical shape, as illustrated in FIG. 7.

Lengths of the nozzle unit 112 and the compensating nozzle unit 112′ may be equal to or greater than a width of the print medium P. The nozzle unit 112 and the compensating nozzle unit 112′ are installed along the second direction, i.e., the y direction. The second direction may be perpendicular to the first direction, i.e., the transferring direction of the print medium P. The printhead having the nozzle unit 112 and the compensating nozzle unit 112′ may be controlled by the control unit 130.

Referring to FIG. 8, a printhead according to another embodiment of the present general inventive concept may include a head chip-type nozzle unit 112 and a compensating nozzle unit 112′. As illustrated in FIG. 8, the nozzle unit 112 and the compensating nozzle unit 112′ may be formed on a single head chip. Head chips H1 and H2 may be arranged in a single line or in two lines to alternate with each other along a direction perpendicular to the transferring direction of the print medium P (i.e., the width direction of the print medium P). Each of the head chips H1 and H2 are connected to a cable (not shown) to receive printing data, electric power, control signals, etc. The cable may be a flexible printed circuit (FPC) or a flexible flat cable (FFC).

The compensating nozzle unit 112′ may be installed with the nozzle unit 112 (see FIGS. 3 through 8) in the printhead 111 or separately installed in another nozzle unit 111′, as illustrated in FIG. 9. In addition, the compensating nozzle unit 112′ may be installed in front of or behind the nozzle unit 112. The nozzle unit 112 and the compensating nozzle unit 112′ may be formed on a single head chip or on separate head chips. The compensating nozzle unit 112′ and the nozzle unit 112 may be formed on a single chip installed along the width direction of the print medium P. A plurality of the head chips having the compensating nozzle unit 112′ and the nozzle unit 112 may be arranged to alternate with one another along two lines parallel to the width direction of the print medium P. The nozzle unit 112 and the compensating nozzle unit 112′ can be variously embodied in many different forms and should not be construed as being limited to the embodiments set forth therein. In addition, although the printheads illustrated in FIGS. 4 through 9 eject only ink of one color, the present general inventive concept can be applied to a color printhead ejecting ink of different colors.

A removable cartridge type ink container may be provided in the body 110 (see FIG. 3). Further, the body 110 may include chambers, each having ejecting units (for example, piezoelectric elements or heat-driving typed heaters) that are connected to respective nozzles of the nozzle units 112 and provide pressure to eject the ink, a passage (for example, an orifice) to supply the ink contained in the body 110 to each chamber, a manifold that is a common passage to supply the ink flowing through the passage to the chamber, and a restrictor that is an individual passage to supply the ink from the manifold to each chamber. The chamber, the ejecting unit, the passage, the manifold, and the restrictor are well-known to a person skilled in the art, and thus detailed descriptions thereof will not be presented.

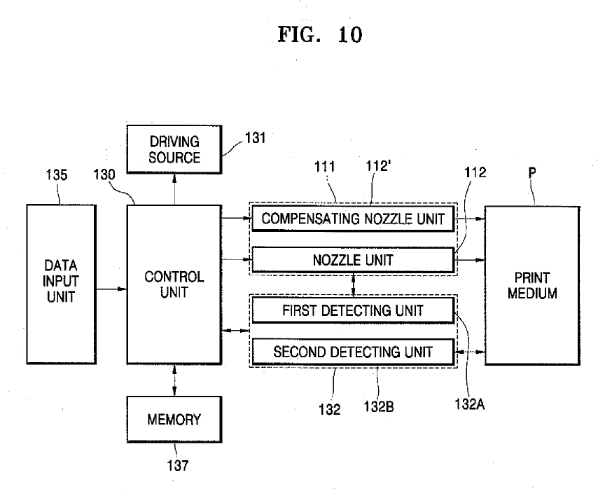

FIG. 10 is a block diagram illustrating an inkjet image forming apparatus capable of compensating for a malfunctioning nozzle according to an embodiment of the present general inventive concept. Referring to FIG. 10, the inkjet image forming apparatus includes a data input unit 135 to receive image data in the order of pages to be printed from an external device, such as a personal computer (PC), a digital camera, or a personal digital assistant (PDA).

The inkjet image forming apparatus further includes a control unit 130 that can be mounted on a motherboard (not illustrated) to control an ink ejecting operation of a nozzle unit 112 and a compensating nozzle unit 112′ installed in a printhead 111, and a transferring operation of a print medium transferring unit 500. That is, the control unit 130 controls each component of the inkjet image forming apparatus so that the nozzle unit 112 and the compensating nozzle unit 112′ eject ink on desired regions of a print medium P. In addition, the control unit 130 stores the image data input through the data input unit 135 in a memory 137, and confirms whether the image data desired to be printed is completely stored in the memory 137. When an operation of storing the image data is completed, the control unit 130 operates a driving source 131, and the print medium P is transferred by the print medium transferring unit 500 that is driven by the driving source 131.

When there is no malfunctioning nozzle, the control unit 130 controls the nozzle unit 112 to eject ink onto the print medium P when the print medium P approaches the nozzle unit 112. The control unit 130 generates and outputs a first control signal to control an operation of the nozzle unit 112 such that the image data is printed on the print medium P. The nozzle unit 112 receives the first control signal and ejects ink according to the image data on the print medium P. When a malfunctioning nozzle is detected, the control unit 130 generates and outputs a second signal to control an operation of the compensating nozzle unit 112′ adjacent to an area where ink ejected from the malfunctioning nozzle would have been ejected, and then the compensating nozzle unit 112′ receives the second control signal and ejects ink to compensate for the malfunctioning nozzle.

Hereinafter, an operation of compensating for a malfunctioning nozzle in the printhead of the inkjet image forming apparatus according to an embodiment of the present general inventive concept will be described.

The first and second detecting unit 132A and 132B detect a malfunctioning nozzle in the nozzle unit 112. An operation of detecting a malfunctioning nozzle in the nozzle unit 112 is described above, and thus a detailed description thereof will be omitted.

When all nozzles work properly or at least there is no malfunctioning nozzle in an area to be printed, a regular printing operation will be performed. However, when a malfunctioning nozzle exists in an area to be printed, a missing line, such as a visible white line, will appear on the print medium because the malfunctioning nozzle irregularly ejects ink (or the malfunctioning nozzle may not eject ink at all). Thus, the printed image quality is degraded due to the presence of the missing line. Therefore, a nozzle of the compensating nozzle unit 112′ that is adjacent to the detected malfunctioning nozzle compensates for the missing line.

According to the above structures and method, a printhead and an inkjet image forming apparatus having the same according to the present general inventive concept can compensate for missing dots generated by malfunctioning nozzles, by using nozzles of a compensating nozzle unit 112′, which are positioned between the nozzles of the nozzle unit 112, thereby preventing visible printing defects such as a white line. Also, the printhead and the inkjet image forming apparatus having the same according to the present general inventive concept can prevent the printed image quality degradation caused by the malfunctioning nozzles because the compensating nozzles are closely positioned to the malfunctioning nozzles, compared with the left and right side nozzles of the malfunctioning nozzles as in conventional methods. In addition, the printhead and the inkjet image forming apparatus having the same according to the present general inventive concept can compensate for the malfunctioning nozzles for other colors as well as the black color. The method of compensating for malfunctioning nozzles according to the present general inventive concept can be enhanced by adjusting sizes and optimizing arrangement of nozzles of the compensating nozzle unit 112′.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A printhead comprising:
a nozzle unit having a main nozzle array to eject ink on a print medium to print an image; and
a compensating nozzle unit having a secondary nozzle array separately installed in a transferring direction of the print medium to compensate for malfunctioning nozzles in the nozzle unit, wherein each nozzle disposed in the secondary nozzle array of the compensating nozzle unit is positioned between nozzles disposed in the main nozzle array of the nozzle unit.

2. The printhead of claim 1, wherein each nozzle disposed in the secondary nozzle array of the compensating nozzle unit is positioned in a range of ¼ to ¾ of a gap between two adjacent nozzles disposed in the main nozzle array of the nozzle unit.

3. The printhead of claim 1, wherein each nozzle disposed in the secondary nozzle array of the compensating nozzle unit is substantially at a center of a gap between two adjacent nozzles disposed in the main nozzle arrays of the nozzle unit.

4. The printhead of claim 1, wherein diameters of nozzles in the compensating nozzle unit are equal to or larger than diameters of nozzles in the nozzle unit, and equal to or less than twice the diameters of the nozzles in the nozzle unit.

5. The printhead of claim 1, wherein each nozzle disposed in the secondary nozzle array of the compensating nozzle unit has an elliptical shape.

6. The printhead of claim 1, wherein the nozzle unit has a length corresponding to a width of the print medium.

7. The printhead of claim 1, wherein the compensating nozzle unit has a length corresponding to a width of the print medium.

8. The printhead of claim 1 comprising:
a plurality of head chips, each head chip including the nozzle unit and the compensating nozzle unit, wherein the plurality of the head chips are installed in one line or in two lines alternating with one another along a direction perpendicular to the transferring direction of the print medium.

9. The printhead of claim 1, wherein the main nozzle array includes a first and a second nozzle array to eject ink of same color and the first and the second array are separately positioned at a predetermined distance from each other along the transferring direction of the print medium, and nozzles of the first and second nozzle arrays are positioned to alternate with one another in a direction perpendicular to the transferring direction of the print medium.

10. A printhead, comprising:
a head chip;
a nozzle unit formed in the head chip having nozzles to eject ink; and
a compensating nozzle unit formed in the head chip and having compensating nozzles to eject compensating solution to diffuse the ink.

11. An inkjet image forming apparatus comprising:
a printhead to eject ink on a print medium to print an image thereon, wherein the printhead includes a nozzle unit having a main nozzle array to eject ink on the print medium to print an image; and
a compensating nozzle unit having a secondary nozzle array which is separately installed in a transferring direction of the print medium to compensate for malfunctioning nozzles in the nozzle unit, wherein each nozzle disposed in the secondary nozzle array of the compensating nozzle unit is positioned between nozzles disposed in the main nozzle array of the nozzle unit.

12. The inkjet image forming apparatus of claim 11, further comprising:
a detecting unit to detect malfunctioning nozzles in the nozzle unit.

13. The inkjet image forming apparatus of claim 12, further comprising:
a control unit to control the printhead to compensate for the malfunctioning nozzles in the nozzle unit based on information on the malfunctioning nozzles generated by the detecting unit.

14. The inkjet image forming apparatus of claim 13, wherein each nozzle disposed in the secondary nozzle array of the compensating nozzle unit is positioned in a range of ¼ to ¾ of a gap between two adjacent nozzles disposed in the main nozzle array of the nozzle unit.

15. The inkjet image forming apparatus of claim 13, wherein the position of each nozzle disposed in the secondary nozzle array of the compensating nozzle unit is substantially at a center of a gap between two adjacent nozzles disposed in the main nozzle arrays of the nozzle unit.

16. The inkjet image forming apparatus of claim 13, wherein diameters of nozzles in the compensating nozzle unit are equal to or larger than diameters of nozzles in the nozzle unit, and equal to or less than twice the diameters of the nozzles in the nozzle unit.

17. The inkjet image forming apparatus of claim 13, wherein the control unit controls the printhead such that a size of ink droplets ejected from nozzles in the compensating nozzle unit is equal to or larger than a size of ink droplets ejected from the nozzle unit, and equal to or less than twice the size of ink droplets ejected from the nozzle unit.

18. The inkjet image forming apparatus of claim 13, wherein each nozzle disposed in the secondary nozzle array of the compensating nozzle unit has an elliptical shape.

19. The inkjet image forming apparatus of claim 13, wherein the nozzle unit has a length corresponding to a width of the print medium.

20. The inkjet image forming apparatus of claim 13, wherein the compensating nozzle unit has a length corresponding to a width of the print medium.

21. The inkjet image forming apparatus of claim 13 comprising:
a plurality of head chips, each of which includes the nozzle unit and the compensating nozzle unit, wherein the plurality of the head chips are installed in one line or in two lines to alternate with one another, along a direction perpendicular to the transferring direction of the print medium.

22. The inkjet image forming apparatus of claim 11, wherein the main array of the nozzle unit comprises:
a first and a second nozzle array to eject ink of the same color and the first and the second array are separately positioned at a predetermined distance from each other along the transferring direction of the print medium, and nozzles in the first and second nozzle array are positioned to alternate with one another in a direction perpendicular to the transferring direction of the print medium.

23. An image forming apparatus, comprising:
a printhead to print to a print medium, the printhead including a first plurality of nozzles to eject ink to a plurality of first portions of the print medium and a second plurality of nozzles to eject compensating solution to a plurality of second portions of the print medium that are adjacent to the first portions;
a detecting unit to detect one or more of the first nozzles that malfunction; and
a control unit to control the printhead according to which of the one or more first nozzles that malfunction.
